(19) United States
(12) Patent Application Publication
(10) Pub. No.: US 2006/0213895 A1
(43) Pub. Date: Sep. 28, 2006

(54) Heater jacket

(76) Inventor: Sandra D. Dennis, Las Vegas, NV (US)

Correspondence Address: Raymond M. Galasso;Galasso & Associates LP, P.O. Box 26503, Austin, TX, 78755-0503, US

(21) Appl. No.: 11/087,880

(22) Filed: Mar. 23, 2005

(51) Int. Cl. H05B 1/00; H05B 11/00

(52) U.S. Cl. 219/211; 219/529

(57) ABSTRACT

A heater jacket is provided comprising an outer shell; an inner liner; batting; a waistband; two arms with cuffs; a collar; ribbing comprising flexible, elastic material at the collar, cuffs, and waistband; an inner liner; a set of heating elements; a battery compartment with metal contacts; a battery; a controls compartment; a set of controls, and means to hold the jacket shut. The conductive heating elements may comprise flexible metal elements such as those used in an electric heating blanket and conduct throughout the jacket the electricity generated by the battery. To use the heater jacket, the wearer would put a battery into the battery pocket in connection with the metal contacts, put on the jacket, and use the controls to cause the jacket to become warm to the desired degree. After use, the heating elements may be turned off and the jacket may be taken off and stored.

### FIELD OF THE DISCLOSURE

The present invention relates to electrically heated garments, and more particularly, to a battery-powered, electrically heated jacket.

### BACKGROUND

During the course of a day, keeping warm can be a challenge. For instance, an individual may be working outdoors during a cold day with a chilly breeze. Similarly, an individual can be working in a cold room such as a windowless office, a basement or an attic or may be undergoing medical treatments such as chemotherapy that can cause a drop in body temperature. Moreover, people who stay outside for long periods in cold weather, such as sportsmen, sports fans, construction workers, soldiers, sailors, and police officers, often must struggle to stay warm.

As a result, these individuals may have to resort to different methods of keeping warm. Some people put on warm jackets, heavy-duty coats, flannel shirts or sweatshirts. Others choose to use blankets or to sip hot drinks such a coffee, hot tea or hot chocolate. While these solutions may be effective in some circumstances, they may prove inadequate in really cold weather or for prolonged exposure to cold conditions. Therefore, attempts have been made to design mechanically heated garments capable of more effectively protecting people from cold conditions.

For example, U.S. Pat. No. 5,269,369 provides a temperature regulation system for the human body that uses heat pipes, capable of conveying heated fluid or electrical power, to distribute energy to and from portions of a body to provide heating or cooling by redistributing body heat. The heat pipes are incorporated into a garment, a blanket and a pad which may be used for medical treatment or activities or for activities in environments having extreme temperatures.

Supplemental means for heating and cooling are included to improve heating or cooling to a body, and to provide heating or cooling to limited areas of a body.

U.S. Pat. No. 5,008,517 for Brekkestran provides for a complicated electrically heated fabric assembly for use with an electrically heated garment. The fabric assembly includes a lightweight, stretchable, form-fitting fabric made from polyphthalate and spandex fibers for covering various portions of the body of a wearer of the garment; and a plurality of flexible, electrical, heat generating wires arranged in a serpentine pattern on various portions of the fabric, and operable to generate heat in response to an electrical current flow through the heating wires. The heating wires are secured to the fabric by cover stitching, accomplished by sewing, to allow the fabric to retain its flexibility. The heating wires each include several conductor elements wound together in a spiral fashion, and each conductor element includes a core portion having wound there around in a spiral fashion two tinsel-like copper conductors. The core portions each consist of several aromatic polyamide fibers of extremely high tensile strength. A plurality of winged connector assemblies operable to be sewably attached to the fabric are also included for removably connecting the heating wires to an external power source.

However, prior techniques such as the ones given above are typically complicated assemblies of technology, often designed to provide heat throughout the entire body, which may make them expensive, difficult to use, unattractive, and cumbersome to wear in ordinary situations such as outdoor sports events.

Therefore there is a need for an apparatus such as a heater jacket that provides a simple, attractive, less cumbersome, and less expensive method for providing electrically heated clothing.

### SUMMARY OF THE DISCLOSURE

The following explanation describes the present invention by way of example and not by way of limitation.

It is an aspect of the present invention to provide an apparatus comprising electrically heated clothing that is simple in design.

It is an aspect of the present invention to provide an apparatus comprising electrically heated clothing that is potentially attractive for multiple users.

It is an aspect of the present invention to provide an apparatus comprising electrically heated clothing that is easy to use.

It is an aspect of the present invention to provide an apparatus comprising electrically heated clothing that is inexpensive.

It is an aspect of the present invention to provide an apparatus comprising electrically heated clothing that is highly portable.

These and other aspects, features, and advantages are achieved according to the present invention.

In an embodiment of the present invention, a heater jacket is provided in the form of a long-sleeved jacket. The heater jacket is specifically designed to provide conductive electrical heating to its wearer and comprises
an outer shell,
batting,
a waistband,
two arms with flexible cuffs,
a collar,
ribbing,
an inner liner,
a set of conductive heating elements,
a battery compartment with metal contacts,
a portable battery,
a controls compartment,
a set of controls, and
a zipper.
   Dimensions

In an embodiment, the heater jacket is twenty-six inches in overall length and one and a half inches in thickness.

In other embodiments, the heater jacket can be in other sizes, to accommodate different wearers and different weather conditions. For example, the heater jacket could be two inches in thickness to provide greater padding and reduction of heat loss from within the jacket.

Outer Shell

In an embodiment the outer shell is made of rayon. It reduces the dispersal of heat that is built up within the jacket. Note that this outer shell could be in any of a variety of attractive colors. In an embodiment, this outer shell is blue.

Batting

The batting provides padding within the jacket that retains heat built up within the jacket by the conductive heating elements and the wearer's body heat. The padding also provides protection to the wearer from direct contact with the heating elements. The batting may comprise any useful material, for example cotton, wool, or a synthetic material, rolled up or in sheets.

Waistband

The waistband reduces loss in the waist area of heat built up within the jacket.

Arms

The arms with flexible cuffs reduce loss in the arm areas of heat built up within the jacket.

Collar

The collar reduces loss in the neck area of heat built up within the jacket.

Ribbing

The ribbing comprises flexible, elastic material at the cuffs, collar, and waistband to enable the heater jacket to fit tightly enough in those areas to reduce heat loss from within the heater jacket, without the material being stretched out of shape permanently during use.

Inner Liner

The inner liner provides another layer of material that reduces loss of heat built up within the jacket and also protects the wearer from direct contact with the heating elements. In an embodiment, the inner lining is made of cotton.

Heating Elements

The conductive heating elements are metal elements such as those used in an electric heating blanket, well known to those skilled in the art, that conduct throughout the jacket the electricity generated by the battery. The electricity thus increases the motion of electrons and atoms within the heating elements, producing heat. Note that the heating elements may comprise flexible metal to allow the wearer of the heater jacket to move about easily.

Battery Compartment

In an embodiment, the battery compartment is located in the waistband of the jacket on the wearer's left side and comprises metal contacts that enable the conduction of electricity from the battery to the heating elements through a wire. Snaps attached to the top flap of the battery compartment may be used to hold the battery securely in place.

Portable Battery

The portable battery may comprise any type of battery technology appropriate to portable heated clothing. For example, in an embodiment a rechargeable nickel metal hydride battery weighing approximately one pound may be used, in association with an appropriate 110 volt AC wall charger. In other embodiments other types of rechargeable or non-rechargeable batteries may be used, for example a sealed gel cell battery, or a lithium ion battery. Alternately a battery pack comprising multiple D cell batteries may be used.

Controls Compartment

In an embodiment, the controls compartment is located in the waistband of the jacket on the wearer's right side. Snaps attached to the top flap of the control compartment may be used to hold the controls securely in place.

Controls

In an embodiment the controls are plastic controls such as those used in an electric heating blanket. These controls enable the wearer of the jacket to control the amount of electricity generated by the battery and thus the amount of heat produced by the heating elements.

Note that in an embodiment the controls can be used in association with one or more thermostats that automatically regulate the amount of electricity used, and thus the amount of heat generated.

Zipper

The zipper can be zipped shut to hold the two front sides of the jacket together to reduce the loss of heat generated within the jacket. In an embodiment, the zipper is made of plastic.

Use

To use the heater jacket, the wearer would put a battery into the battery pocket in connection with the metal contacts, put on the jacket, and use the controls to cause the jacket to become warm to the desired degree. After use, the heating elements of the jacket could be turned off and the jacket would be taken off and stored. In an embodiment, the battery may be plugged into a re-charger for recharging.

With its simplicity of design, the heater jacket described above is effective, inexpensive, easy to use, and highly portable since the heater jacket does not need to be plugged into an electrical outlet but is powered through a small, portable battery. It also comprises a standard, attractive jacket design and color that almost anyone would be proud to wear.

### Other Embodiments

Note that in other embodiments the elements of the heater jacket could be made of different materials, as useful. For example, the outer shell could be made of cotton, wool, or leather. The inner lining could be made of wool. The zipper could be made of metal.

In other embodiments, the design of the heater jacket could be further altered from the design given above, as useful. For example, the zipper could be replaced by Velcro strips to hold the jacket shut. The heater jacket could also comprise multiple battery compartments instead of one, so that it could employ multiple batteries for use over long periods of time. The battery compartments and controls could also be located in other areas of the heater jacket than the waistband, for example in pockets on the sides of the heater jacket.

These and other embodiments of the present invention will become readily apparent upon further review of the following specification and associated drawings.

### BRIEF DESCRIPTION OF THE DRAWINGS

The following embodiment of the present invention is described by way of example only, with reference to the accompanying drawings, in which:

FIG. 1 illustrates a frontal view of a heater jacket.

FIG. 2 illustrates a cutaway frontal view of a heater jacket, showing the heating elements.

FIG. 3 a frontal view of a battery used for a heater jacket.

### DETAILED DESCRIPTION OF THE DRAWINGS

The following description of drawings is offered to illustrate the present invention clearly. However, it will be apparent to those skilled in the art that the concepts of present invention are not limited to these specific details. Commonly known elements are also shown in diagrams for clarity, as examples and not as limitations of the present invention.

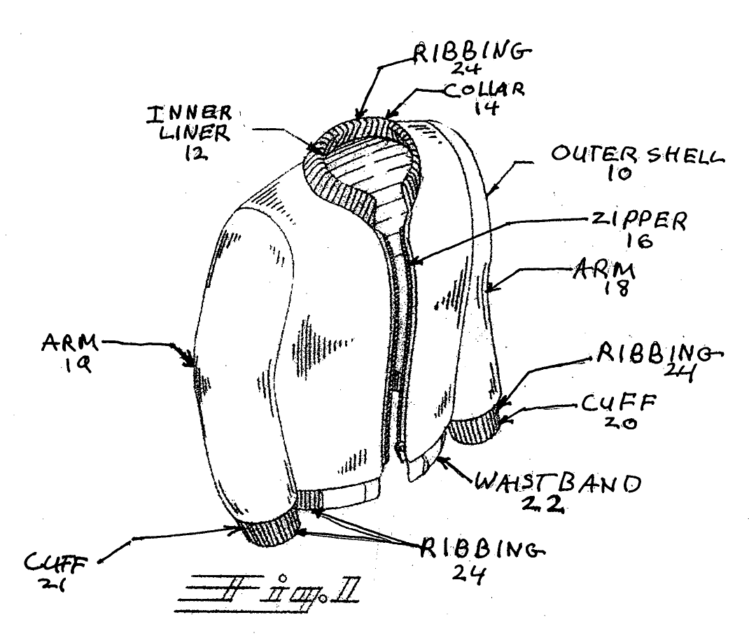

FIG. 1 illustrates a frontal view of an embodiment of a heater jacket. A blue, rayon outer shell 10 reduces the dispersal of heat that is built up within the jacket and provides an attractive look. A cotton inner liner 12 fits inside the outer shell 10 and provides another layer of material that reduces loss of heat built up within the jacket and also protects the wearer from direct contact with the heating elements. Flexible ribbing 24, at the collar 14, waistband 22, and cuffs 20 and 21 of the arms 18 and 19; reduces heat loss from within the heater jacket. A zipper 16 is used to close the jacket.

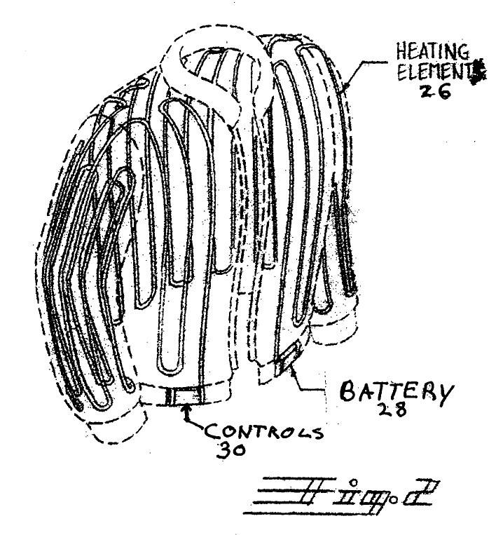

FIG. 2 illustrates a cutaway frontal view of an embodiment of a heater jacket. Heating elements 26 provide heat for the heater jacket using electrical power supplied by a battery 28. The wearer of the heater jacket can regulate the supply of power and thus heat by a set of controls 30.

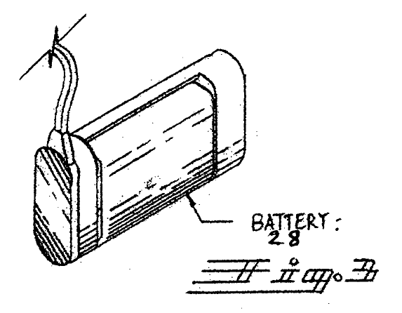

FIG. 3 a frontal view of a battery 28 used for a heater jacket.

1. An apparatus for providing an electrically heated heater jacket, comprising
an outer shell;
batting;
a waistband;
two arms with cuffs;
a collar;
ribbing;
comprising flexible, elastic material at the collar, cuffs, and waistband;
an inner liner;
a set of heating elements;
a battery compartment with metal contacts;
a battery pack comprising multiple D cell batteries;
a controls compartment;
a set of controls, and
means to hold the jacket shut.

2. The apparatus of claim 1 wherein the outer shell is made of rayon.

3. The apparatus of claim 1 wherein the inner liner is made of cotton.

4. The apparatus of claim 1 wherein the set of heating elements comprises flexible metal elements.

5. The apparatus of claim 1 wherein the battery compartment is located in the waistband of the heater jacket.

6. (canceled)

7. (canceled)

8. The apparatus of claim 1 wherein the set of controls is made of plastic.

9. The apparatus of claim 1 wherein the controls compartment is located in the waistband of the heater jacket.

10. The apparatus of claim 1 wherein the means to hold the jacket shut comprises a zipper.

11. The apparatus of claim 1 wherein the means to hold the jacket shut comprises one or more Velcro strips.

12. An apparatus for providing an electrically heated heater jacket, comprising
An outer shell made of rayon;
batting;
a waistband;
two arms with cuffs;
a collar;
ribbing;
comprising flexible, elastic material at the collar, cuffs, and waistband;
an inner liner made of cotton;
a set of heating elements comprising flexible metal elements;
a battery compartment with metal contacts;
a battery pack comprising multiple D cell batteries;
a controls compartment;
a set of plastic controls, and
means to hold the jacket shut.

13. The apparatus of claim 12 wherein the battery compartment is located in the waistband of the heater jacket.

14. (canceled)

15. (canceled)

16. The apparatus of claim 12 wherein the controls compartment is located in the waistband of the heater jacket.

17. The apparatus of claim 12 wherein the means to hold the jacket shut comprises a zipper.

18. The apparatus of claim 12 wherein the means to hold the jacket shut comprises one or more Velcro strips.

19. An apparatus for providing an electrically heated heater jacket, comprising
a blue outer shell made of rayon and twenty-six inches in overall length and one and a half inches in thickness;
batting;
a waistband;
two arms with cuffs;
a collar;
ribbing;
comprising flexible, elastic material at the collar, cuffs, and waistband;
an inner liner made of cotton;
a set of heating elements comprising flexible metal elements;
a battery compartment with metal contacts and located in the waistband of the heater jacket;
a battery pack comprising multiple D cell batteries;
a controls compartment located in the waistband of the heater jacket;
a set of plastic controls, and
a plastic zipper.
